(19) United States
(12) Patent Application Publication
(10) Pub. No.: US 2008/0035881 A1
(43) Pub. Date: Feb. 14, 2008

(54) Composition for anticorrosion wax

(76) Inventor: Jeum Sub Kim, Suwon-si (KR)

Correspondence Address: MORGAN, LEWIS & BOCKIUS LLP (SF), 2 PALO ALTO SQUARE, 3000 El Camino Real, Suite 700, PALO ALTO, CA, 94306, US

(21) Appl. No.: 11/595,402

(22) Filed: Nov. 8, 2006

(30) Foreign Application Priority Data
Aug. 9, 2006 (KR) 10-2006-0075231

(51) Int. Cl. C09K 5/00

(52) U.S. Cl. 252/71

(57) ABSTRACT

The present invention relates to a composition for anticorrosion wax. In particular, it relates to a composition for anticorrosion wax comprising naphthene-based mineral oil, wax, anticorrosion additive, alkyd resin, and additives. The additives include an oxidized petroleum wax and a microcrystalline wax which are mixed in an optimum ratio in the wax. The additives may also include calcium petroleum sulfonate and barium dinonylnaphthalene sulfonate which enhance anticorrosion. The anticorrosion wax reduces volatile organic components and may be applied to the body of a car.

### CROSS-REFERENCE TO RELATED APPLICATIONS

This application claims priority to Korean Patent Application No. 10-2006-0075231, filed Aug. 9, 2006 the disclosures of which are incorporated herein by reference.

### BACKGROUND OF THE INVENTION

(a) Field of the Invention

The present invention relates to a composition for anticorrosion wax.

(b) Description of the Related Art

Recently, there have been attempts made to protect the car from harmful environments by using wax. Conventionally, the anticorrosion wax was diluted with a solvent along with additives and coated on a car, followed by drying the solvent. In this regard, the conventional anticorrosion wax has a problem in that the evaporated solvent is removed by using a drying machine such as a ventilator fan.

Thus, there has long been a need for developing a wax that does not use an additional drying machine and produces a reduced amount of volatile components.

The present invention fulfills this long-desired need by using naphthene-based mineral oil instead of a using a solvent comprising volatile components.

Thus, the present invention aims to provide a composition for anticorrosion wax that remarkably reduces the production of toxic volatile organic components and the fluidity of composition after being coated on the body of a car.

### SUMMARY OF THE INVENTION

The present invention provides a composition for anticorrosion wax comprising: a) about 10 to about 20 wt % of a naphthene-based mineral oil, b) about 15 to about 25 wt % of a wax mixed with an oxidized petroleum wax and a microcrystalline wax in a weight ratio of about 10:5 to about 15:10 c) about 45 to about 65 wt % of an anticorrosion additive mixed with a calcium petroleum sulfonate and a barium dinonylnaphthalene sulfonate in a weight ratio of about 10:35 to about 20:45, d) about 10 to about 30 wt % of an alkyd resin, and e) about 0.5 to about 2 wt % of at least one additive selected from the group consisting of an antifoaming agent, a drying agent, a surfactant and antiscratch coating material.

In one embodiment, the antifoaming agent is an acryl polymer. In another embodiment, the drying agent is a cobalt catalyst. In another embodiment the surfactant is a fatty acid ester. In another embodiment, the antiscratch coating material is an oxime compound.

### DETAILED DESCRIPTION OF THE INVENTION

The present invention relates to a composition for anticorrosion wax comprising a naphthene-based mineral oil, wax, anticorrosion additive, alkyd resin, and additives. In one embodiment, additives include, but are not limited to, oxidized petroleum wax and the microcrystalline wax which are both mixed in an optimum ratio in the wax. In another embodiment, additives also include, but are not limited to, calcium petroleum sulfonate and the barium dinonylnaphthalene sulfonate which enhance anticorrosion by acting as anticorrosion additives. The anticorrosion wax therefore reduces volatile organic components and may be applied to the body of a car.

The present invention relates to a composition for anticorrosion wax comprising: about 10 to about 20 wt % of a naphthene-based mineral oil; about 15 to about 25 wt % of a wax mixed with an oxidized petroleum wax and a microcrystalline wax in a weight ratio of about 10:5 to about 15:10; about 45 to about 65 wt % of an anticorrosion additive mixed with a calcium petroleum sulfonate and a barium dinonylnaphthalene sulfonate in a weight ratio of about 10:35 to about 20:45; about 10 to about 30 wt % of an alkyd resin and; about 0.5 to about 2 wt % of other additives.

Oil is used to dissolve wax, anticorrosion additive, alkyd resin and additives, while facilitating the spraying of anticorrosion wax. The main ingredient in oil is hydrocarbon. The crude petroleum is subject to the atmospheric distillation, and the resultant petroleum residues are in turn subject to the reduced distillation. Oil is prepared by separating the fraction after distillation. Oil is classified according to its flash point. General oil comprises aromatic components which are cancer-causing agents. Consequently, the present invention uses highly purified naphthene-based mineral oil instead of general oil. The naphthene-based mineral oil is preferred to have a viscosity of about 3 cSt at about 100° C. and a flash point of about 100° C. or higher, and is comprised in an amount of about 10 to about 20 wt %. If the content of the naphthene-based mineral oil is below 10 wt % the oil may prevent spraying due to high viscosity. If the content of the naphthene-based mineral oil is above 20 wt %, the oil may extend the drying time, and cause fluidity after spraying.

In one embodiment, wax comprises saturated hydrocarbons as its main ingredient. In the present invention, the wax serves as a coat-forming material, water-blocking barrier, and corrosion preventer. As the melting point is higher, the water improves as a repellent and the water is temperature-sensitive. The wax comprises saturated hydrocarbons, and due to its high temperature-sensitivity, the viscosity increases abruptly at low temperatures. Thus, the present invention adopts a mixture of the oxidized petroleum wax and the microcrystalline wax in a weight ratio of about 10:5 to about 15:10. If the weight ratio is below 10:5, the wax may cause corrosion because it flows easily after coating. If the weight ratio is above 15:10, the wax may extend the drying time.

The oxidized petroleum wax has a melting point of about 80° C. and a total acid number of about 17.5 mg KOH/g. The microcrystalline wax is generally referred to as “microwax”. The microwax is a winterized wax which is prepared from lube distillate and de-asphalted oil by means of solvent extraction. The microwax comprises side-chain saturated hydrocarbons. The microwax is typically white or yellow, needle-shaped and has additive property. The microwax shows high content of distillated fractions because of high affinity to distillated fractions. In combination with other waxes such as mineral oil and vegetable wax, the microwax is used to increase a melting point and hardness. The microwax has saturated hydrocarbons at side chains, and show relatively low viscosity change with temperature. Thus, the microwax may supplement oxidized petroleum wax showing relatively high viscosity change with temperature. The microwax has a melting point of about 70° C. and a total acid number of about 1.5 mg KOH/g, and may be comprised in an amount of about 15 to about 25 wt %. If the content is below 15 wt %, the microwax may deteriorate the function of anticorrosion wax because of low anticorrosive property and cause the composition to flow down after being coated due to too low viscosity. If the content of the microwax is above 25 wt %, the microwax may extend drying time.

As for the anticorrosion additives, the present invention includes, but is not limited to, calcium petroleum sulfonate and barium dinonylnaphthalene sulfonate in a weight ratio of about 10:35 to about 20:45. If the weight ratio is below 10:35, the anticorrosion additives may deteriorate the anticorrosive property. If the weight ratio is above 20:45, the anticorrosion additives may affect fluidity.

Metal salt sulfonate is widely used as an anticorrosion additive, and is known to have different anticorrosive property according to the alkyl group. The double bond of oxygen in the metal salt sulfonate forms a chemical adsorption with metal, and prevents moisture and oxygen, which are the causes of corrosion from sticking to the metal surface. Further, sulfonates are used to manufacture soaps by adding metal ions which affect the properties of the sulfonate. Generally, barium ion shows the best anticorrosive property, and calcium ion is superior as a heat-resistant property. The sulfonate also stabilizes wax in a solution system, and thus enhances the fluidity of the solution. The calcium petroleum sulfonate herein has a melting point of about 182° C. and a total acid number of about 45 mg KOH/g. The barium dinonylnaphthalene sulfonate herein is in a liquid state and has an absolute viscosity of about 10000 cP. It is used in the amount of about 45 to about 65 wt %. If the content is below 45 wt %, the metal salt sulfonate may deteriorate the anticorrosive property. If the content is above 65 wt %, fluidity may be affected.

Alkyd resin may be obtained by reacting an ester, which is obtained from polybasic acid and polyalcohol, with fatty acid or oil. Alkyd resin herein is non-volatile fraction 100% resin herein. The alkyd resin herein has a kinematic viscosity of about 31 cSt at about 40° C. and a total acid number of about 22 mg KOH/g, and is preferred to be comprised in an amount of about 10 to about 30 wt %. If the content is below 10 wt %, the alkyd resin flows down the anticorrosion wax. If the content is above 30 wt % the alkyd resin deteriorates storage stability.

Examples of other additives herein includes, but is not limited to, an antifoaming agent for preventing foam from occurring in anticorrosion wax, a surfactant which causes moisture on the surface of a car body to be adsorbed into the anticorrosion wax, a drying agent for oxidizing alkyd resin, antiscratch coating materials for preventing curing of exposed surface at early stage of storage and the combination thereof. The amount of the aforementioned additives is about 0.5 to about 2 wt %. If the content is below 0.5 wt %/o, the additives may cause the composition to flow down due to undried alkyd resin. If the content is above 2 wt %, the additives may render the spraying impossible to perform because the composition may be dried at early stage. In one embodiment, acryl polymer, fatty acid ester, cobalt catalyst, and oxime compound may be used in the present invention as the aforementioned antifoaming agent, surfactant, drying agent and antiscratch coating materials, respectively.

### EXAMPLES

The present invention is described more specifically by the following Examples. Examples herein are meant only to illustrate the present invention, but in no way to limit the claimed invention.

### Examples 1-3

A composition for anticorrosion wax was prepared by admixing components as shown in TABLE 1, and the test results were provided in TABLE 2.

### Comparative Example 1

The same procedure was followed as Example 1 except the wax has a naphtha solvent content of 55%, and test results were provided in TABLE 2.

### Comparative Example 2

Water-soluble anticorrosion wax was prepared as described in Example 1 of Korean patent publication no. 10-2006-0021198.

TABLE 1

| | | Examples 1–3 | | | | | |
|---|---|---|---|---|---|---|---|
| Ingredients (wt %) | | 1 | | 2 | | 3 | |
| Anti- | Calcium petroleum | 12.02 | | 20.00 | | 17.0 | |
| corrosion | sulfonate | | | | | | |
| additives | Barium | 35.00 | | 25.80 | | 28.00 | |
| | dinonylnaphthalene | | | | | | |
| | sulfonate | | | | | | |
| Wax | Oxidized petroleum | 10.00 | | 13.0 | | 9.0 | |
| | wax | | | | | | |
| | Microcrystalline wax | 8.51 | | 5.79 | | 6.4 | |
| Oil | Naphthene oil | 15.1 | | 15.1 | | 22.2 | |
| Resin | Alkyd resin | 18.5 | | 18.5 | | 15.4 | |
| Others | Acryl polymer | 0.2 | 0.87 | 0.4 | 1.81 | 0.2 | 2.0 |
| additives | Cobalt catalyst | 0.2 | | 0.5 | | 1.0 | |
| | Fatty acid ester | 0.27 | | 0.51 | | 0.4 | |
| | Oxime compound | 0.2 | | 0.4 | | 0.4 | |

### Test Methods

A pre-measured amount of sample (about 2 g) was placed on a flat container. Then, the sample was dried at 105-110° C. for 3 hours in a forced ventilation drier, and cooled in a dessicator. The weight of the non-volatile fraction (g) was measured, and the non-volatile fraction (wt %) was calculated with the following formula. Non-volatile fraction (wt %)=Non-volatile fraction (g)/Sample (g)×100

Salt spray testing was performed according to KSM 2109.

Viscosity was measured by using Brookfield Viscometer.

Secondary fluidity was measure; Steel plate (SPCC) with dimension of 0.8 t×70×150 mm was washed with detergent, and coated with an anticorrosion composition (thickness: 100 μm). After 24 hours, the coated plate was placed perpendicularly at 80±5° C., and the distance (mm) that the coating flowed was measured.

Effect on coated layer was evaluated according to KSM 5400 (Test method for general coating materials).

Effect on rubber was evaluated according to KSM 5400 (Test method for general coating materials).

TABLE 2

| | Examples 1–3 | | | Comparative Examples | |
|---|---|---|---|---|---|
| | 1 | 2 | 3 | C. E. 1 | C. E. 2 |
| Non-volatile | Above | Above | Above 98% | 43% | 27% |
| fraction | 98% | 98% | | | |
| (wt %) | | | | | |
| Salt spray | No | No effect | No effect | No effect | No effect |
| test | effect | | | | |
| Viscosity cP | 1970 | 1700 | 1590 | 700 | 870 |
| at 20° C. | | | | | |
| Secondary | 3 | 0 | 0 | 3 | 42 |
| fluidity | | | | | |
| Effect on | No | No effect | No effect | No effect | No effect |
| coated layer | effect | | | | |
| Effect on | No | No effect | No effect | No effect | No effect |
| rubber | effect | | | | |

As set forth above, Examples 1-3 showed higher non-volatile fraction and superior viscosity property, and remarkably reduced toxic volatile organic component than Comparative Examples 1-2.

Thus, the composition for anticorrosion wax of the present invention is superior in reducing toxic volatile organic components, improving fluidity, and effecting coating and rubber.

What is claimed is:

1. A composition for anticorrosion wax comprising:
(a) about 10 to about 20 wt % of a naphthene-based mineral oil;
(b) about 15 to about 25 wt % of a wax mixed with an oxidized petroleum wax and a microcrystalline wax in a weight ratio of about 10:5 to about 15:10;
(c) about 45 to about 65 wt % of an anticorrosion additive mixed with a calcium petroleum sulfonate and a barium dinonylnaphthalene sulfonate in a weight ratio of about 10:35 to about 20:45;
(d) about 10 to about 30 wt % of an alkyd resin; and
(e) about 0.5 to about 2 wt % of at least one additive selected from the group consisting of an antifoaming agent, a drying agent, a surfactant and antiscratch coating material.

2. The composition for anticorrosion wax of claim 1, wherein the antifoaming agent is an acryl polymer.

3. The composition for anticorrosion wax of claim 1, wherein the drying agent is a cobalt catalyst.

4. The composition for anticorrosion wax of claim 1, wherein the surfactant is a fatty acid ester.

5. The composition for anticorrosion wax of claim 1, wherein the antiscratch coating material is an oxime compound.
